(19) United States
(12) Patent Application Publication
(10) Pub. No.: US 2023/0189047 A1
(43) Pub. Date: Jun. 15, 2023

(54) RELAY APPARATUS, WIRELESS COMMUNICATION SYSTEM AND WIRELESS COMMUNICATION METHOD

(71) Applicant: NIPPON TELEGRAPH AND TELEPHONE CORPORATION, Tokyo (JP)

(72) Inventors: Daisuke GOTO, Musashino-shi (JP); Kiyohiko ITOKAWA, Musashino-shi (JP); Yasuyoshi KOJIMA, Musashino-shi (JP); Fumihiro YAMASHITA, Musashino-shi (JP); Yosuke FUJINO, Musashino-shi (JP); Kento YOSHIZAWA, Musashino-shi (JP)

(73) Assignee: NIPPON TELEGRAPH AND TELEPHONE CORPORATION, Tokyo (JP)

(21) Appl. No.: 17/923,628

(22) PCT Filed: May 22, 2020
(86) PCT No.: PCT/JP2020/020373

§ 371 Date: Nov. 7, 2022

(51) Int. Cl. H04W 28/02; H04B 7/195; H04B 7/185

(52) U.S. Cl. CPC H04W 28/0205; H04B 7/195; H04B 7/18519

(57) ABSTRACT

A relay device provided in a moving body and communicating with a plurality of communication devices present at different locations in a wireless manner includes a reception unit that receives a signal transmitted from each of the plurality of communication devices, a measurement unit that measures a degree of congestion of communication in the reception unit, and a transmission unit that transmits information to each communication device when the relay device is located in a range in which the relay device is able to communicate with the communication device, the information being used to determine the number of times of transmission of the signal to be transmitted from the communication device and being based on the degree of congestion.

### TECHNICAL FIELD

The present disclosure relates to a relay apparatus, a wireless communication system and a wireless communication method.

### BACKGROUND ART

Internet of Things (IoT) systems, which achieve various applications by connecting small terminal devices to the Internet, have become widespread. As an application example of the IoT system, a system is known in which a plurality of IoT terminals sense environmental information such as a temperature, a room temperature, an acceleration, and a luminous intensity and transmit the environmental information using wireless signals and a cloud collects the environmental information. IoT terminals including various sensors are installed at various locations. For example, it is also assumed that the IoT may be utilized to collect data at a location at which installing a base station is difficult, such as a buoy or a ship at sea, and a mountainous area.

On the other hand, there is a wireless system that performs wireless communication between a plurality of ground communication devices using a communication satellite, an unmanned aerial vehicle (UAV), or the like as a relay station. As a wireless system that uses a communication satellite as a relay station, there are a case where a low earth orbit (LEO) satellite making a low earth orbit of at an altitude of approximately 1,000 km is used, and a case where a geostationary orbit (GEO) satellite orbiting at an altitude of 36,000 km is used. The low earth orbit satellite has a shorter propagation distance than that of the geostationary orbit satellite. For this reason, in a case where a low earth orbit satellite is used as a relay station, it is possible to achieve communication having a low delay and a low propagation loss. In this case, it becomes easy to configure a high-frequency circuit included in the low earth orbit satellite or a ground communication device. However, the low earth orbit satellite orbits in the sky of the Earth unlike a geostationary orbit satellite, and thus the orientation of the satellite which is seen from the ground communication device changes constantly. A visible time per orbit of the low earth orbit satellite from each ground communication device is several minutes. For this reason, a time slot in which the low earth orbit satellite and each ground communication device can communicate is limited.

On the other hand, a low power wide area (LPWA) is known as a wireless system that is capable of performing wide area communication with low power and at a low transmission rate and is suitable for communication of IoT terminals. Currently, satellite IoT systems in which a communication satellite collects data from IoT terminals using LPWA are under sturdy. In general, wireless communication between a communication satellite and a ground communication device has a longer propagation distance than that of wireless communication for performing direct communication between a plurality of ground communication devices. However, it is possible to apply LPWA by using a low earth orbit satellite. In the case of such a satellite IoT system, it is possible to accommodate IoT terminals in the fields of aviation and ships, and in rural areas, which have been difficult with only ordinary LPWA. In this case, it becomes easy to develop services because a hub station is not required.

Now, the number of IoT terminals is steadily increasing. In addition, because LPWA has a low data rate, a period of time for which an IoT terminal is transmitting data is relatively long. For this reason, there is concern that an increase in the number of IoT terminals results in an increase in collision of data packets. On the other hand, for example, NPL 1 discloses a technique for avoiding a collision at the time of data reception in a base station by autonomous distributed transmission schedule control of a terminal in an LPWA network. In the technique disclosed in PTL 1, a transmission timing of each terminal is represented by a phase oscillator model. When data to be transmitted is generated, the terminal waits until its own phase is set to zero and then transmits the data. The technique is intended to avoid a collision of data by achieving an anti-phase synchronization state in which phases of all terminals are arranged at equal intervals.

### CITATION LIST

### Non Patent Literature

NPL 1: Daichi Kominami, Ikkyu Aihara, Masayuki Murata, “Self-organized transmission scheduling for LPWA networks considering gateway load balancing,” IEICE Technical Report, vol. 117 no. 353 IN2017-67, pp. 127-132, December 2017

### SUMMARY OF THE INVENTION

### Technical Problem

In an IoT system, each IoT terminal may repeat data transmission to a base station a plurality of times in order to secure reliability of communication. In addition, because a large number of IoT terminals transmit data, transmission opportunities may exceed the number of slots. In this manner, in an IoT system, the degree of congestion of communication may vary from time to time. However, in the technique disclosed in NPL 1, terminals uniformly transmit data at different timings given to the respective terminals. Further, in the technique, a transmission schedule is not controlled in accordance with the occupancy status of a base station. For this reason, the technique disclosed in NPL 1 has a problem that the reliability of communication is reduced due to collision of data in a case where the degree of congestion of communication varies.

In view of the above-described circumstances, an object of the present disclosure is to provide a relay apparatus, a wireless communication system and a wireless communication method capable of suppressing reduction in reliability of communication even when the degree of congestion of communication varies.

### Means for Solving the Problem

An aspect of the present disclosure is a relay device provided in a moving body and communicating with a plurality of communication devices present at different locations in a wireless manner, the relay device including a reception unit that receives a signal transmitted from each of the plurality of communication devices, a measurement unit that measures a degree of congestion of communication in the reception unit, and a transmission unit that transmits information to each communication device when the relay device is located in a range in which the relay device is able to communicate with the communication device, the information being used to determine the number of times of transmission of the signal to be transmitted from the communication device and being based on the degree of congestion.

An aspect of the present disclosure is a wireless communication system including a plurality of communication devices present at different locations, and a relay device provided in a moving body and communicating with the plurality of communication devices in a wireless manner, in which the relay device includes a first reception unit that receives a signal transmitted from each of the plurality of communication devices, a measurement unit that measures a degree of congestion of communication in the first reception unit, and a first transmission unit that transmits congestion degree information based on the degree of congestion to each communication device when the relay device is located in a range in which the relay device is able to communicate with the communication device, and each communication device includes a second reception unit that receives the congestion degree information, and a second transmission unit that transmits the signal to the relay device the number of times of transmission determined based on the congestion degree information.

An aspect of the present disclosure is a wireless communication system including a plurality of communication devices present at different locations, and a plurality of relay devices communicating with the plurality of communication devices in a wireless manner, each relay device being provided in a corresponding one of a plurality of moving bodies, in which each relay device includes a first reception unit that receives a signal transmitted from each of the plurality of communication devices, a measurement unit that measures a degree of congestion of communication in the first reception unit, and a first transmission unit that transmits congestion degree information based on the degree of congestion to each communication device when the relay device is located in a range in which the relay device is able to communicate with the communication device in a case where the measured degree of congestion is relatively low among the degrees of congestion measured in the plurality of relay devices, and each communication device includes a second reception unit that receives the congestion degree information, and a second transmission unit that transmits, to the relay device that has transmitted the congestion degree information, the signal the number of times of transmission determined based on the congestion degree information.

An aspect of the present disclosure is a wireless communication method executed by a relay device provided in a moving body and communicating with a plurality of communication devices present at different locations in a wireless manner, the wireless communication method including a reception step of receiving a signal transmitted from each of the plurality of communication devices, a measurement step of measuring a degree of congestion of communication in the reception step, and a transmission step of transmitting information to each communication device when the relay device is located in a range in which the relay device is able to communicate with the communication device, the information being used to determine the number of times of transmission of the signal to be transmitted from the communication device and being based on the degree of congestion.

An aspect of the present disclosure is a wireless communication method executed by a wireless communication system including a plurality of communication devices present at different locations, and a relay device provided in a moving body and communicating with the plurality of communication devices in a wireless manner, the wireless communication method including a first reception step of, by the relay device, receiving a signal transmitted from each of the plurality of communication devices, a measurement step of, by the relay device, measuring a degree of congestion of communication in the first reception step, a first transmission step of, by the relay device, transmitting congestion degree information based on the degree of congestion to each communication device when the relay device is located in a range in which the relay device is able to communicate with the communication device, a second reception step of, by each communication device, receiving the congestion degree information, and a second transmission step of, by each communication device, transmitting the signal to the relay device the number of times of transmission determined based on the congestion degree information.

An aspect of the present disclosure is a wireless communication method executed by a wireless communication system including a plurality of communication devices present at different locations, and a plurality of relay devices communicating with the plurality of communication devices in a wireless manner, each relay device being provided in a corresponding one of a plurality of moving bodies, the wireless communication method including a first reception step of, by each relay device, receiving a signal transmitted from each of the plurality of communication devices, a measurement step of, by each relay device, measuring a degree of congestion of communication in the first reception step, a first transmission step of, by each relay device, transmitting congestion degree information based on the degree of congestion to each communication device when the relay device is located in a range in which the relay device is able to communicate with the communication device in a case where the measured degree of congestion is relatively low among the degrees of congestion measured in the plurality of relay devices, a second reception step of, by each communication device, receiving the congestion degree information, and a second transmission step of, by each communication device, transmitting, to the relay device that has transmitted the congestion degree information, the signal the number of times of transmission determined based on the congestion degree information.

### Effects of the Invention

According to the present disclosure, it is possible to suppress reduction in reliability of communication even when the degree of congestion of communication varies.

### BRIEF DESCRIPTION OF DRAWINGS

FIG. 1 is a configuration diagram of a wireless communication system according to a first embodiment of the present disclosure.

FIG. 2 is a flowchart illustrating data collecting processing of the wireless communication system according to the first embodiment.

FIG. 3 is a flowchart illustrating data collecting processing of the wireless communication system according to the first embodiment.

FIG. 4 is a flowchart illustrating transmission control processing of the wireless communication system according to the first embodiment.

FIG. 5 is a configuration diagram of a wireless communication system according to a first modification example of the first embodiment of the present disclosure.

FIG. 6 is a flowchart illustrating data collecting processing of the wireless communication system according to the first modification example.

FIG. 7 is a configuration diagram of a wireless communication system according to a second modification example of the first embodiment of the present disclosure.

FIG. 8 is a flowchart illustrating data collecting processing of the wireless communication system according to the second modification example.

FIG. 9 is a flowchart illustrating transmission control processing of the wireless communication system according to the second modification example.

FIG. 10 is a configuration diagram of a wireless communication system according to a second embodiment of the present disclosure.

FIG. 11 is a flowchart illustrating processing of the wireless communication system according to the second embodiment.

### DESCRIPTION OF EMBODIMENTS

Hereinafter, embodiments of the present disclosure will be described in detail with reference to the drawings.

### First Embodiment

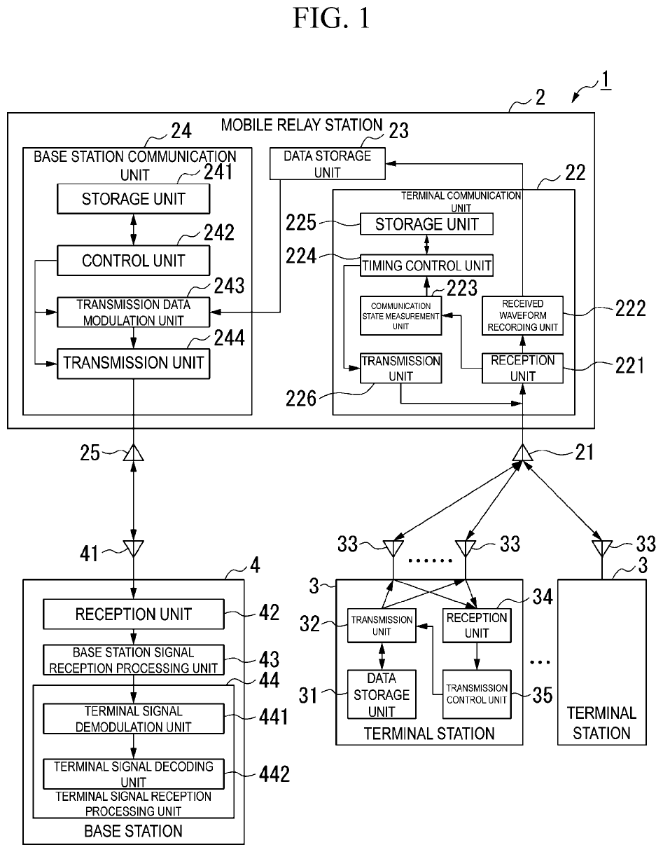

FIG. 1 is a configuration diagram of a wireless communication system 1 according to a first embodiment. The wireless communication system 1 includes a mobile relay station 2, a terminal station 3, and a base station 4. The number of the mobile relay stations 2, the number of the terminal stations 3, and the number of the base stations 4 included in the wireless communication system 1 can be freely determined, and the number of the terminal stations 3 is assumed to be large. The wireless communication system 1 is a communication system transmitting information that does not require immediacy. Information transmitted from the plurality of terminal stations 3 is transmitted via the mobile relay station 2 and collected by the base station 4.

The mobile relay station 2 is an example of a relay device (apparatus) mounted on a moving body and having a communication area moving over time. The mobile relay station 2 is provided in, for example, a low earth orbit (LEO) satellite. The altitude of the LEO satellite is 2000 km or less, and the LEO satellite orbits once over the Earth in approximately 1.5 hours. The terminal stations 3 and the base station 4 are installed on the Earth, such as on the ground or at sea. The plurality of terminal stations 3 are present at different locations. Each terminal station 3 is, for example, an IoT terminal. The terminal station 3 collects data such as environment data detected by a sensor and transmits the collected data to the mobile relay station 2 in a wireless manner. FIG. 1 illustrates only two terminal stations 3. The mobile relay station 2 receives the data transmitted from each of the plurality of terminal stations 3 in a wireless manner while moving in the sky of the Earth. The mobile relay station 2 stores the received data and collectively transmits the stored data to the base station 4 in a wireless manner at a timing when the mobile relay station 2 can communicate with the base station 4. The base station 4 receives the data collected by the terminal stations 3 from the mobile relay station 2.

As the mobile relay station 2, it is conceivable to use a relay station mounted on an unmanned aerial vehicle such as a geostationary orbit satellite, a drone, and a high altitude platform station (HAPS). However, in the case of a relay station mounted on a geostationary orbit satellite, a coverage area on the ground (footprint) is wide, but the altitude thereof is high, and thus a link budget for an IoT terminal installed on the ground is extremely small. On the other hand, in the case of a relay station mounted on a drone or an HAPS, a link budget is high, but a coverage area is narrow. Further, a drone requires a battery, and an HAPS requires a solar panel. In the present embodiment, the mobile relay station 2 is mounted on an LEO satellite. Thus, in addition to a link budget falling within a limit, the LEO satellite, which orbits outside the atmosphere, has no air resistance and less fuel consumption. In addition, a footprint is also large as compared to a case where a relay station is mounted on a drone or an HAPS.

The mobile relay station 2 mounted on the LEO satellite performs communication while moving at high speed, and thus a time when the individual terminal stations 3 and the base station 4 can communicate with the mobile relay station 2 is limited. Specifically, when viewed from the ground, the mobile relay station 2 passes through the sky above for approximately 10 minutes. In addition, wireless communication schemes having various specifications are used for the terminal station 3. Consequently, the mobile relay station 2 receives a terminal uplink signal from the terminal station 3 in a coverage at the present position during movement and stores waveform data of the received terminal uplink signal. The mobile relay station 2 transmits a base station downlink signal in which the waveform data of the terminal uplink signal is set to the base station 4 in a wireless manner at a timing when the base station 4 is present within the coverage. The base station 4 demodulates the base station downlink signal received from the mobile relay station 2 to obtain the waveform data of the terminal uplink signal. The base station 4 performs demodulation and decoding on the terminal uplink signal represented by the waveform data to obtain terminal transmission data which is data transmitted by the terminal station 3.

Note that, in the wireless communication system 1 according to the present embodiment, it is assumed that the mobile relay station 2 and the terminal station 3 perform wireless communication using a low power wide area (LPWA). In order to secure the reliability of communication, the terminal stations 3 may transmit the same terminal uplink signal to the mobile relay station 2 a plurality of times. Further, as described above, the number of the terminal stations 3 is assumed to be large. With such a configuration, the amount of communication of data transmitted from the terminal stations 3 to the mobile relay station 2 may increase, and a communication band may become scarce. The wireless communication system 1 according to the present embodiment controls a transmission timing and the number of times of transmission of data from each terminal station 3 to the mobile relay station 2 in order to prevent a communication band from becoming scarce.

Specifically, the mobile relay station 2 previously transmits, to each terminal station 3, a control signal indicating that the mobile relay station 2 is permitted to transmit data such as environment data to the mobile relay station 2 (hereinafter referred to as a “transmission permission signal”). In addition, the transmission permission signal includes information used to determine the number of times the same terminal uplink signal is to be repeatedly transmitted by the terminal station 3 to the mobile relay stations 2. The information is based on the degree of congestion of communication between the mobile relay station 2 and the plurality of terminal stations 3 (hereinafter referred to as “congestion degree information”). The congestion degree information is, for example, information indicating the number of accesses of terminal uplink communication per unit time from the plurality of terminal stations 3 to the mobile relay station 2 or a received signal intensity indicator (RSSI) in a frequency band of the terminal uplink communication.

The terminal station 3 starts to transmit the terminal uplink signal to the mobile relay station 2 in response to the reception of the transmission permission signal. In addition, the terminal station 3 determines the number of times the same terminal uplink signal is to be repeatedly transmitted to the mobile relay station 2 based on the congestion degree information included in the received transmission permission signal.

Further, configurations and operations of the devices in processing for controlling a transmission timing and the number of times of transmission of the terminal uplink signal from each terminal station 3 to the mobile relay station 2 (hereinafter referred to as “transmission control processing”) will be described below in detail. Hereinafter, details of configurations and operations of the devices in processing in which the base station 4 collects data such as environment data transmitted from each terminal station 3 through the mobile relay station 2 (hereinafter referred to as “data collecting processing”) will be first described.

Data Collecting Processing

Configurations of the devices in the data collecting processing will be described.
The mobile relay station 2 includes an antenna 21, a terminal communication unit 22, a data storage unit 23, a base station communication unit 24, and an antenna 25.
The terminal communication unit 22 includes a reception unit 221 and a received waveform recording unit 222. The reception unit 221 receives a terminal uplink signal by the antenna 21. The received waveform recording unit 222 samples a received waveform of the terminal uplink signal received by the reception unit 221 and generates waveform data indicating a value obtained by the sampling. The received waveform recording unit 222 writes received waveform information in the data storage unit 23, the received waveform information being information in which a reception time of the terminal uplink signal in the antenna 21 and the generated waveform data are set. The data storage unit 23 stores the received waveform information written by the received waveform recording unit 222.

The base station communication unit 24 transmits the received waveform information to the base station 4 using a base station downlink signal of any wireless communication scheme. The base station communication unit 24 includes a storage unit 241, a control unit 242, a transmission data modulation unit 243, and a transmission unit 244. The storage unit 241 stores a transmission start timing which is calculated in advance, based on orbit information of an LEO satellite on which the mobile relay station 2 is mounted, and the position of the base station 4. The orbit information of the LEO is information with which the position, speed, moving direction, and the like of the LEO satellite at any time can be obtained. The transmission time may be represented by, for example, an elapsed time from the transmission start timing.

The control unit 242 controls the transmission data modulation unit 243 and the transmission unit 244 so as to transmit the received waveform information to the base station 4 at the transmission start timing stored in the storage unit 241. The transmission data modulation unit 243 reads the received waveform information from the data storage unit 23 as transmission data and modulates the read transmission data to generate a base station downlink signal. The transmission unit 244 converts the base station downlink signal from an electrical signal into a wireless signal and transmits the wireless signal from the antenna 25.

Each terminal station 3 includes a data storage unit 31, a transmission unit 32, and one or a plurality of antennas 33. The data storage unit 31 stores sensor data and the like. The transmission unit 32 reads the sensor data from the data storage unit 31 as terminal transmission data, and transmits a terminal uplink signal having the read terminal transmission data set therein from the antenna 33 in a wireless manner. The transmission unit 32 transmits the signal by low power wide area (LPWA). Examples of LPWA include LoRaWAN (registered trademark), Sigfox (registered trademark), long term evolution for machines (LTE-M), and a narrow band (NB)-IoT, and any wireless communication scheme can be used. In addition, the transmission unit 32, as well as the transmission units 32 of the other terminal stations 3, may perform transmission by time division multiplexing, orthogonal frequency division multiplexing (OFDM), or the like. The transmission unit 32 determines a channel to be used to transmit the terminal uplink signal by the terminal station, and a transmission timing by a method determined in advance in a wireless communication scheme to be used. In addition, the transmission unit may perform beam formation of a signal to be transmitted from the plurality of antennas 33 by a method determined in advance in a wireless communication scheme to be used.

The base station 4 includes an antenna 41, a reception unit 42, a base station signal reception processing unit 43, and a terminal signal reception processing unit 44. The reception unit 42 converts the base station downlink signal received by the antenna 41 into an electrical signal. The base station signal reception processing unit 43 performs demodulation and decoding of the received signal converted into an electrical signal by the reception unit 42 to obtain received waveform information. The base station signal reception processing unit 43 outputs the received waveform information to the terminal signal reception processing unit 44.

The terminal signal reception processing unit 44 performs processing for receiving a terminal uplink signal indicated by the received waveform information. In this case, the terminal signal reception processing unit 44 performs reception processing by a wireless communication scheme used for transmission by the terminal station 3 to acquire terminal transmission data. The terminal signal reception processing unit 44 includes a terminal signal demodulation unit 441 and a terminal signal decoding unit 442.

The terminal signal demodulation unit 441 demodulates waveform data and outputs a symbol obtained by demodulation to the terminal signal decoding unit 442. The terminal signal demodulation unit 441 may perform demodulation after performing processing for compensating for a Doppler shift of a terminal uplink signal received by the antenna 21 of the mobile relay station 2 on a signal indicated by the waveform data. The Doppler shift of the terminal uplink signal received by the antenna 21 is calculated in advance based on the position of the terminal station 3 and the orbit information of the LEO on which the mobile relay station 2 is mounted. The terminal signal decoding unit 442 decodes the symbol demodulated by the terminal signal demodulation unit 441 to obtain terminal transmission data transmitted from the terminal station 3.

Operations of the wireless communication system 1 in the data collecting processing will be described.

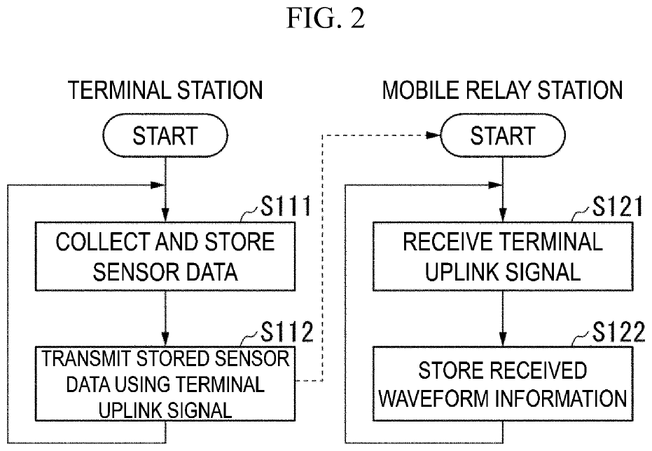

FIG. 2 is a flowchart illustrating processing of the wireless communication system 1 in a case where a terminal uplink signal is transmitted from each terminal station 3. The terminal station 3 acquires data detected by a sensor (not illustrated) provided outside or inside the terminal station 3 at any time, and writes the acquired data in the data storage unit 31 (step S111). The transmission unit 32 reads the sensor data from the data storage unit 31 as terminal transmission data. The transmission unit 32 transmits a terminal uplink signal having the terminal transmission data set therein from the antennas 33 in a wireless manner at a transmission start timing which is obtained in advance based on the orbit information of the LEO satellite on which the mobile relay station 2 is mounted (step S112). The terminal station 3 repeats the processing from step S111.

The reception unit 221 of the mobile relay station 2 receives the terminal uplink signal transmitted from the terminal station 3 (step S121). Depending on a wireless communication scheme of the terminal station 3 which is a transmission source, there are a case where terminal uplink signals are received in a time-division manner from the only one terminal station 3 at the same frequency and a case where terminal uplink signals are simultaneously received from a plurality of the terminal stations 3 at the same frequency. The received waveform recording unit 222 writes received waveform information in the data storage unit 23, the received waveform information being information in which waveform data representing a waveform of the terminal uplink signal received by the reception unit 221 and a reception time are associated with each other (step S122). The mobile relay station 2 repeats the processing from step S121.

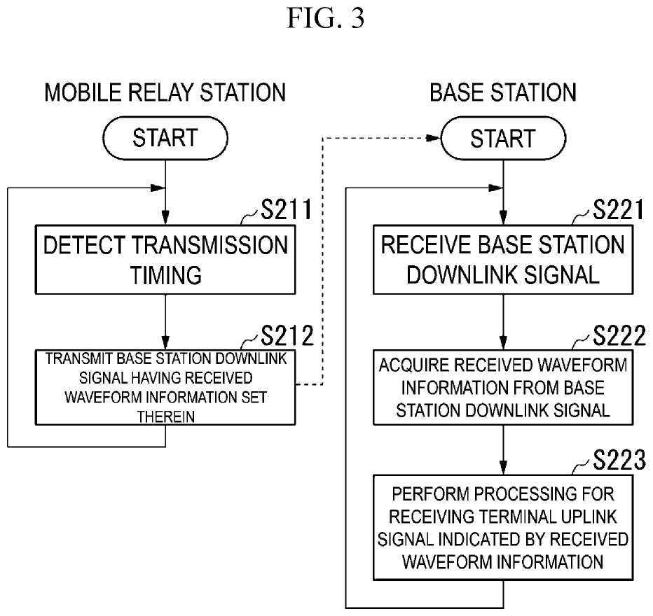

FIG. 3 is a flowchart illustrating processing of the wireless communication system 1 in a case where a base station downlink signal is transmitted from the mobile relay station 2. When the control unit 242 included in the base station communication unit 24 of the mobile relay station 2 detects a transmission start timing stored in the storage unit 241, the control unit 242 instructs the transmission data modulation unit 243 and the transmission unit 244 to transmit received waveform information (step S211). The transmission data modulation unit 243 reads the received waveform information stored in the data storage unit 23 as transmission data, and modulates the read transmission data to generate a base station downlink signal. The transmission unit 244 transmits the base station downlink signal generated by the transmission data modulation unit 243 from the antenna 25 in a wireless manner (step S212). The mobile relay station 2 repeats the processing from step S211.

The antenna 41 of the base station 4 receives the base station downlink signal from the mobile relay station 2 (step S221). The reception unit 42 converts the base station downlink signal received by the antenna 41 into a received signal which is an electrical signal, and outputs the received signal to the base station signal reception processing unit 43. The base station signal reception processing unit 43 demodulates the received signal and decodes the demodulated received signal (step S222). The base station signal reception processing unit 43 outputs received waveform information obtained by the decoding to the terminal signal reception processing unit 44.

The terminal signal reception processing unit 44 performs processing for receiving a terminal uplink signal represented by a waveform data included in the received waveform information (step S223). Specifically, the terminal signal demodulation unit 441 identifies a wireless communication scheme that the terminal station 3 has used to transmit the terminal uplink signal, based on wireless communication scheme specific information included in the received signal represented by the waveform data. The terminal signal demodulation unit 441 demodulates the received signal represented by the waveform data in accordance with the identified wireless communication scheme, and outputs a symbol obtained by the demodulation to the terminal signal decoding unit 442. The terminal signal decoding unit 442 decodes the symbol input from the terminal signal demodulation unit 441 in accordance with the identified wireless communication scheme to obtain terminal transmission data transmitted from the terminal station 3. Note that the terminal signal decoding unit 442 can also use a decoding scheme having a large calculation load, such as successive interference cancellation (SIC). The base station 4 repeats the processing from step S221.

Transmission Control Processing

Configurations of the devices in the transmission control processing will be described. The configuration of the mobile relay station 2 will be described. As illustrated in FIG. 1, the mobile relay station 2 further includes a communication state measurement unit 223, a timing control unit 224, a storage unit 225, and a transmission unit 226.

The communication state measurement unit 223 measures the communication state of terminal uplink communication from the plurality of terminal stations 3 in the reception unit 221. For example, the communication state measurement unit 223 measures the number of accesses of terminal uplink communication per unit time from the plurality of terminal stations 3, or a received signal intensity in a frequency band of the terminal uplink communication in the reception unit 221. Note that the communication state as mentioned here is any information that quantitatively represents the degree of congestion of communication.

The communication state measurement unit 223 generates congestion degree information based on the measured information. As described above, the congestion degree information is information used to determine the number of times the same terminal uplink signal is to be repeatedly transmitted by the terminal station 3 to each mobile relay station 2. Note that the congestion degree information may be information itself indicating the number of accesses of terminal uplink communication per unit time from the plurality of terminal stations 3 or the received signal intensity in the frequency band of the terminal uplink communication.

Alternatively, the congestion degree information may be information indicating a level determined based on whether information indicating the number of accesses of terminal uplink communication per unit time from the plurality of terminal stations 3 or the received signal intensity in the frequency band of the terminal uplink communication is within a predetermined threshold range. That is, the level is uniquely determined to be, for example, level 1 in a case where the number of accesses of terminal uplink communication per unit time from the plurality of terminal stations 3 is within a certain range, is determined to be level 2 in a case where the number of accesses is within a wider range, or is determined to be level 3 in a case where the number of accesses is within a further wider range. In this case, information in which a range of values of the number of accesses or a received signal intensity and a level are associated with each other is stored in advance in, for example, the storage unit 225.

Alternatively, the congestion degree information may be the value itself of the number of times the same terminal uplink signal is to be repeatedly transmitted by the terminal station 3 to the mobile relay station 2. That is, the value of the number of times of transmission is uniquely determined to be, for example, five times in a case where a received signal intensity in a frequency band of the terminal uplink communication from the plurality of terminal stations 3 is within a certain range, four times in a case where the received signal intensity is within a lower intensity range, or three times in a case where the received signal intensity is within a further lower intensity range. In this case, information in which a range of values of the number of accesses or a received signal intensity and the number of times of transmission are associated with each other is stored in advance in, for example, the storage unit 225 or the like.

The timing control unit 224 controls a timing when a terminal downlink signal having a transmission permission signal set therein is transmitted to each terminal station 3. As described above, the transmission permission signal is a control signal indicating that the terminal station 3 is permitted to transmit data such as environment data to the mobile relay station 2. The timing control unit 224 acquires congestion degree information generated by the communication state measurement unit 223. The timing control unit 224 generates a transmission permission signal including the acquired congestion degree information.

The transmission unit 226 acquires the transmission permission signal generated by the timing control unit 224, and transmits a terminal downlink signal having the acquired transmission permission signal set therein from the antenna 21 in a wireless manner. The transmission unit 226 transmits the signal by LPWA. As LPWA, any wireless communication scheme such as LoRaWAN (trade name), Sigfox (trade name), LTE-M, or an NB-IoT can be used. The transmission unit 226 determines a channel to be used to transmit the terminal downlink signal by the mobile relay station by a method determined in advance in the wireless communication scheme to be used. A timing when the transmission unit 226 transmits the terminal downlink signal is controlled by the timing control unit 224.

The storage unit 225 stores a transmission start timing for each terminal station 3 which is calculated in advance, based on orbit information of the LEO satellite on which the mobile relay station 2 is mounted, and the position of each terminal station 3. The orbit information of the LEO is information with which the position, speed, moving direction, and the like of the LEO satellite at any time can be obtained. The transmission time may be represented by, for example, an elapsed time from the transmission start timing. The timing control unit 224 controls the transmission unit 226 so as to transmit the terminal downlink signal having the transmission permission signal set therein to each terminal station 3 at the transmission start timing for each terminal station 3 stored in the storage unit 225.

As described above, the mobile relay station 2 is provided in, for example, an LEO satellite or the like that orbits in the sky of the Earth at a predetermined cycle. The timing control unit 224 includes, in the transmission permission signal, for example, congestion degree information, which has been generated at the time of receiving a terminal uplink signal from the same terminal station 3 in the past (for example, at a point in time of the previous orbit). Alternatively, the timing control unit 224 may include, in the transmission permission signal, for example, congestion degree information, which has been generated at the time of receiving a terminal uplink signal from the same terminal station 3 in the same time slot in the past. Alternatively, the timing control unit 224 may include, in the transmission permission signal, congestion degree information, which has been generated immediately before a timing when the transmission permission signal is transmitted to the terminal station 3 (for example, 1 minute before).

In addition, the storage unit 225 stores terminal identification information for identifying each terminal station 3 and positional information indicating the position of the terminal station 3 in advance. The timing control unit 224 determines the terminal station 3 to be notified based on the present position of the mobile relay station and the position of the terminal station 3, and specifies terminal identification information of the determined terminal station 3. The timing control unit 224 includes the specified terminal identification information in the transmission permission signal.

A configuration of each terminal station 3 will be described. As illustrated in FIG. 1, the terminal station 3 further includes a reception unit 34 and a transmission control unit 35.

The reception unit 34 receives a terminal downlink signal by the antennas 33.

The transmission control unit 35 acquires a transmission permission signal from the terminal downlink signal received by the reception unit 34. The transmission control unit 35 acquires terminal identification information included in the acquired transmission permission signal. When the acquired terminal identification information is identification information associated with the pertinent terminal station, the transmission control unit 35 acquires congestion degree information included in the acquired transmission permission signal. Note that in a case where the acquired terminal identification information is not identification information associated with the pertinent terminal station, the terminal station 3 waits without starting to transmit data to the mobile relay station 2.

The transmission control unit 35 determines the number of times the same terminal uplink signal is to be repeatedly transmitted to the mobile relay station 2 based on the acquired congestion degree information. For example, the transmission control unit 35 acquires congestion degree information indicating the number of accesses of terminal uplink communication per unit time from the plurality of terminal stations 3, a received signal intensity in a frequency band of the terminal uplink communication, or the like in the reception unit 221. In this case, information in which a range of values of the number of accesses or the received signal intensity and the number of times of transmission are associated with each other is stored in advance in, for example, a storage medium included in the terminal station 3. The transmission control unit 35 determines the number of times of transmission based on the number of accesses or the received signal intensity indicated by the congestion degree information.

Alternatively, for example, the transmission control unit 35 acquires congestion degree information indicating the level of congestion (the above-described level 1, level 2, or the like) in the reception unit 221. In this case, information in which the level of congestion and the number of times of transmissions are associated with each other is stored in advance in, for example, a storage medium included in the terminal station 3. The transmission control unit 35 determines the number of times of transmission based on the level of congestion indicated by the congestion degree information. Alternatively, for example, the transmission control unit 35 acquires congestion degree information indicating the number of times of transmission determined in the mobile relay station 2. In this case, the transmission control unit 35 determines the number of times of transmission indicated by the congestion degree information.

The transmission unit 32 starts to transmit a terminal uplink signal. The transmission unit 32 reads sensor data from the data storage unit 31 as terminal transmission data, and transmits a terminal uplink signal having the read terminal transmission data set therein from the antenna 33 in a wireless manner. The transmission unit 32 transmits the signal by LPWA. In addition, the transmission unit 32 repeatedly transmits the same terminal uplink signal the number of times of transmission determined by the transmission control unit 35.

The reception unit 221 of the mobile relay station 2 receives the terminal uplink signal by the antenna 21. The received waveform recording unit 222 samples a received waveform of the terminal uplink signal received by the reception unit 221 and generates waveform data indicating a value obtained by the sampling. Because the terminal station 3 transmits one piece of sensor data a plurality of times, a plurality of pieces of waveform data corresponding to the same terminal uplink signal are generated.

The received waveform recording unit 222 selects, for example, waveform data having the most satisfactory reception state from among the plurality of pieces of waveform data corresponding to the same terminal uplink signal. The received waveform recording unit 222 writes received waveform information in the data storage unit 23, the received waveform information being information in which a reception time of the terminal uplink signal in the antenna 21 and the selected waveform data are set. The data storage unit 23 stores the received waveform information written by the received waveform recording unit 222. Note that the received waveform recording unit 222 may write, for example, received waveform information in the data storage unit 23, the received waveform information being information in which waveform data generated by averaging the plurality of pieces of waveform data corresponding to the same terminal uplink signal is set.

Operations of the wireless communication system 1 in the transmission control processing will be described.

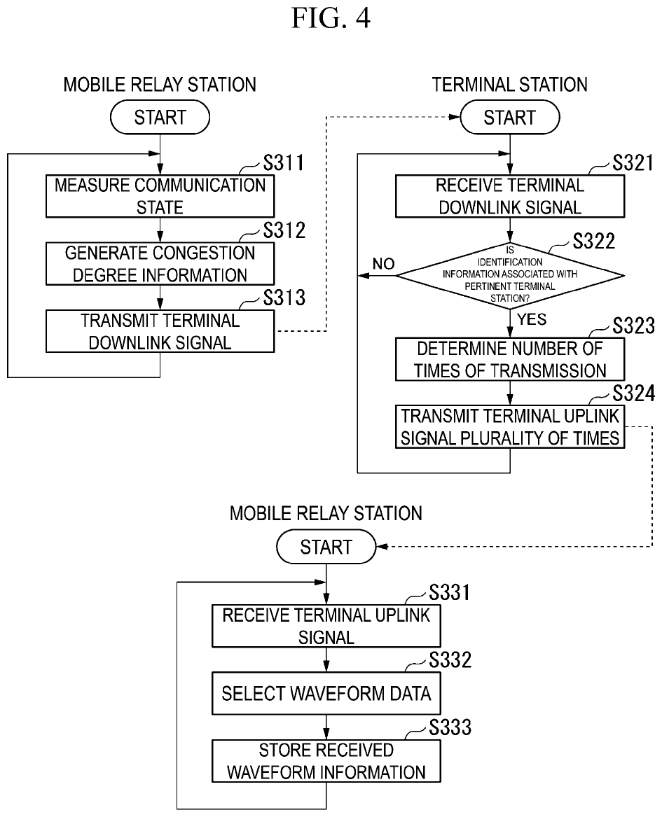

FIG. 4 is a flowchart illustrating processing of the wireless communication system 1 in a case where a terminal downlink signal is transmitted from the mobile relay station 2 to each terminal station 3. The communication state measurement unit 223 of the mobile relay station 2 measures a communication state of terminal uplink communication from the plurality of terminal stations 3 in the reception unit 221 (step S311). As described above, the communication state is, for example, the number of accesses of terminal uplink communication per unit time, a received signal intensity in a frequency band of the terminal uplink communication, or the like.

The communication state measurement unit 223 generates congestion degree information used to determine the number of times the same terminal uplink signal is to be repeatedly transmitted by the terminal station 3 to the mobile relay station 2 based on the measured communication state (step S312). The timing control unit 224 generates transmission permission information including the generated congestion degree information and terminal identification information of the terminal station 3 to be notified. The transmission unit 226 acquires a transmission permission signal generated by the timing control unit 224. The transmission unit 226 transmits a terminal downlink signal having the acquired transmission permission signal set therein from the antenna 21 in a wireless manner, for example, at the time of the next orbit (step S313). The mobile relay station 2 repeats the processing from step S311.

The reception unit 34 of each terminal station 3 receives the terminal downlink signal transmitted from the mobile relay station 2 by the antenna 33 (step S321). The transmission control unit 35 acquires terminal identification information included in the transmission permission signal indicated by the terminal downlink signal received by the reception unit 34. In a case where the acquired terminal identification information is terminal identification information associated with the pertinent terminal station (step S322, Yes), the transmission control unit 35 determines the number of times the same terminal uplink signal is to be repeatedly transmitted to the mobile relay station 2, based on the congestion degree information included in the acquired transmission permission signal (step S323). In a case where the acquired terminal identification information is not terminal identification information associated with the pertinent terminal station (step S322, No), the transmission control unit 35 repeats the processing from step S321.

The transmission unit 32 reads the sensor data from the data storage unit 31 as terminal transmission data, and transmits the terminal uplink signal having the read terminal transmission data set therein from the antennas 33 in a wireless manner. The transmission unit 32 transmits the same terminal uplink signal the number of times of transmission determined by the transmission control unit 35 (step S323). The terminal station 3 repeats the processing from step S321.

The reception unit 221 of the mobile relay station 2 receives the terminal uplink signal transmitted from the terminal station 3 by the antenna 21 a plurality of times (step S331). The received waveform recording unit 222 samples received waveforms of the plurality of terminal uplink signals received by the reception unit 221 and generates waveform data indicating values obtained by the sampling. The received waveform recording unit 222 selects, for example, waveform data having the most satisfactory reception state from among the plurality of pieces of waveform data corresponding to the same terminal uplink signal (step S332). The received waveform recording unit 222 stores received waveform information in the data storage unit 23, the received waveform information being information in which a reception time of the terminal uplink signal in the antenna 21 and the selected waveform data are set (step S333). The mobile relay station 2 repeats the processing from step S331.

As described above, according to the wireless communication system 1 of the first embodiment, the mobile relay station 2 receives the terminal uplink signals transmitted from the plurality of terminal stations 3 and measures a communication state. The mobile relay station 2 generates congestion degree information based on the communication state. The mobile relay station 2 sets the transmission permission signal including the congestion degree information as a terminal downlink signal and transmits the terminal downlink signal to the terminal station 3. The terminal station 3 starts to transmit the terminal uplink signal to the mobile relay station 2 by acquiring the transmission permission signal indicated by the received terminal downlink signal. With such a configuration, the wireless communication system 1 can control a transmission timing of the terminal uplink signal from each terminal station 3 to the mobile relay station 2.

In addition, the terminal station 3 determines the number of times the terminal uplink signal is to be repeatedly transmitted, based on the congestion degree information included in the transmission permission signal. With such a configuration, the wireless communication system 1 can perform control so that the number of times the terminal uplink signal is transmitted from the terminal station 3 is reduced as the degree of congestion of communication in the mobile relay station 2 becomes higher. Thus, the wireless communication system 1 can transmit sensor data transmitted from a greater number of terminal stations 3 to the base station 4 through the mobile relay station 2 while suppressing a reduction in reliability of communication even when the degree of congestion of communication varies.

Note that, as described above, the congestion degree information transmitted from the mobile relay station 2 to the terminal station 3 may be information representing the degree of congestion of communication itself, such as the number of accesses of terminal uplink signals per unit time, and a received signal intensity, or may be information indicating the number of times of transmission determined based on the degree of congestion.

In a case where the congestion degree information is information representing the degree of congestion of communication, the number of times of transmission is determined based on the congestion degree information in the terminal station 3. In this case, it is possible to simplify a device configuration of the mobile relay station 2. In this case, it is also possible to adopt a configuration in which the number of times of transmission is determined from the congestion degree information based on different determination criteria in the respective terminal stations 3. Thus, it is possible to flexibly make a system design.

On the other hand, in a case where the congestion degree information is information indicating the number of times of transmission itself, the number of times of transmission is determined based on the congestion degree information in the mobile relay station 2. In this case, a function of determining the number of times of transmission from the congestion degree information can be centralized in the mobile relay station 2. Further, in particular, in a case where the terminal station 3 is an IoT terminal, a reduction in the device size and in power consumption are generally required, and in this case, a device configuration of the terminal station 3 can be simplified.

### First Modification Example of First Embodiment

In the present modification example, a mobile relay station transmits a base station downlink signal by a plurality of antennas. Hereinafter, a case where multiplex input multiple output (MIMO) is used to transmit a base station downlink signal will be described as an example focusing on differences from the first embodiment.

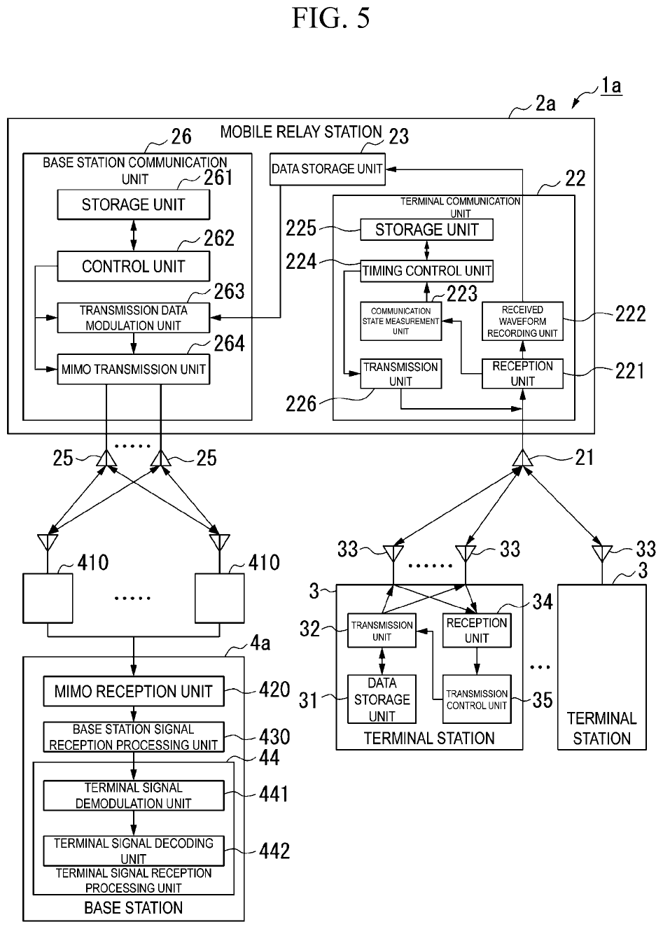

FIG. 5 is a configuration diagram of a wireless communication system 1a according to a first modification example of the first embodiment. In FIG. 5, the same components as those of the wireless communication system 1 according to the first embodiment illustrated in FIG. 1 are denoted by the same reference signs, and description thereof will be omitted. The wireless communication system 1a includes a mobile relay station 2a, a terminal station 3, and a base station 4a.

The mobile relay station 2a includes an antenna 21, a terminal communication unit 22, a data storage unit 23, a base station communication unit 26, and a plurality of antennas 25. The base station communication unit 26 transmits received waveform information to the base station 4a by MIMO. The base station communication unit 26 includes a storage unit 261, a control unit 262, a transmission data modulation unit 263, and a MIMO transmission unit 264. The storage unit 261 stores a transmission start timing calculated in advance, based on orbit information of an LEO satellite on which the mobile relay station 2a is mounted, and the position of the base station 4a. Further, the storage unit 261 stores a weight at each transmission time of a base station downlink signal transmitted from each of the antennas 25 in advance. The weight at each transmission time is calculated based on the orbit information of the LEO satellite and the position of each antenna station 410 included in the base station 4a. Note that a fixed weight may be used regardless of a transmission time.

The control unit 262 controls the transmission data modulation unit 263 and the MIMO transmission unit 264 so as to transmit received waveform information to the base station 4a at a transmission start timing stored in the storage unit 261. Further, the control unit 262 instructs the MIMO transmission unit 264 about a weight at each transmission time read from the storage unit 261. The transmission data modulation unit 263 reads the received waveform information from the data storage unit 23 as transmission data, converts the read transmission data into a parallel signal, and then modulates the parallel signal. The MIMO transmission unit 264 applies the weight instructed by the control unit 262 to the modulated parallel signal to generate a base station downlink signal to be transmitted from each of the antennas 25. The MIMO transmission unit 264 transmits the generated base station downlink signal from each of the antennas 25 by MIMO.

The base station 4a includes a plurality of antenna stations 410, a MIMO reception unit 420, a base station signal reception processing unit 430, and a terminal signal reception processing unit 44. The antenna station 410 is disposed at a position away from the other antenna stations 410 so that a difference between arrival angles of signals from the plurality of antennas 25 of the mobile relay station 2a increases. Each of the antenna stations 410 converts the base station downlink signal received from the mobile relay station 2a into an electrical signal and outputs the electrical signal to the MIMO reception unit 420.

The MIMO reception unit 420 aggregates the base station downlink signals received from the plurality of antenna stations 410. The MIMO reception unit 420 stores a weight at each reception time for the base station downlink signal received by each antenna station 410 based on the orbit information of the LEO satellite and the position of the antenna station 410. The MIMO reception unit 420 multiplies the base station downlink signal input from each of the antenna stations 410 by the weight corresponding to the reception time of the base station downlink signal, and synthesizes a received signal multiplied by the weight. Note that the same weight may be used regardless of a reception time. The base station signal reception processing unit 430 performs demodulation and decoding of the synthesized received signal to obtain received waveform information. The base station signal reception processing unit 430 outputs the received waveform information to the terminal signal reception processing unit 44.

Operations of the wireless communication system 1a will be described.

The processing of the wireless communication system 1a in a case where a terminal uplink signal is transmitted from each terminal station 3 is the same as the processing of the wireless communication system 1 according to the first embodiment illustrated in FIG. 2.

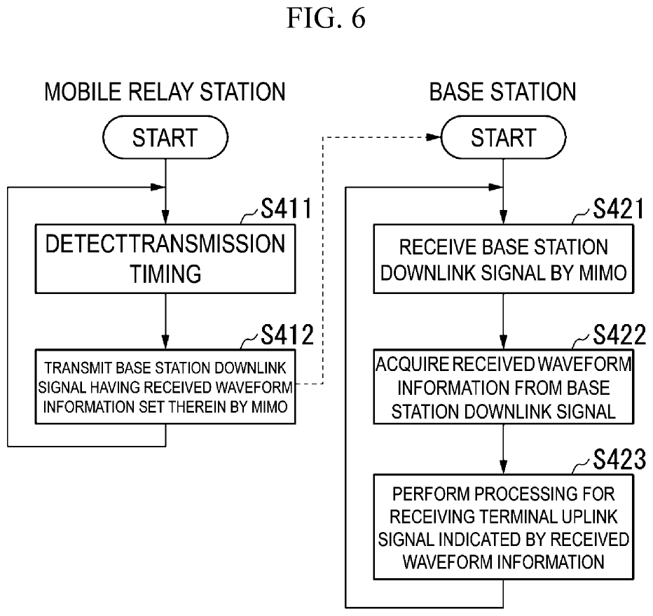

FIG. 6 is a flowchart illustrating processing of the wireless communication system 1a in a case where a base station downlink signal is transmitted from the mobile relay station 2a. Upon detecting a transmission start timing stored in the storage unit 261, the control unit 262 included in the base station communication unit 26 of the mobile relay station 2a instructs the transmission data modulation unit 263 and the MIMO transmission unit 264 to transmit received waveform information (step S411). The transmission data modulation unit 263 reads the received waveform information accumulated in the data storage unit 23 as transmission data, performs parallel conversion of the read transmission data, and then modulates the converted data. The MIMO transmission unit 264 applies a weight instructed by the control unit 262 to the transmission data modulated by the transmission data modulation unit 263 to generate a base station downlink signal which is a transmission signal to be transmitted from each of the antennas 25. The MIMO transmission unit 264 transmits the generated base station downlink signals from the antennas 25 by MIMO (step S412). The mobile relay station 2a repeats the processing from step S411.

Each of the antenna stations 410 of the base station 4a receives the base station downlink signal from the mobile relay station 2a (step S421). Each of the antenna stations 410 outputs a received signal obtained by converting the received base station downlink signal into an electrical signal to the MIMO reception unit 420. The MIMO reception unit 420 synchronizes a timing of the received signal received from each of the antenna stations 410. The MIMO reception unit 420 multiplies the received signals received by the respective antenna stations 410 by a weight and adds the multiplied received signals. The base station signal reception processing unit 430 demodulates the added received signals and decodes the demodulated received signals (step S422). The base station signal reception processing unit 430 outputs received waveform information obtained by the decoding to the terminal signal reception processing unit 44.

The terminal signal reception processing unit 44 performs processing for receiving a terminal uplink signal represented by waveform data included in the received waveform information through processing similar to that of step S223 in the flowchart in the first embodiment illustrated in FIG. 3 (step S423). That is, the terminal signal demodulation unit 441 identifies a wireless communication scheme that the terminal station 3 has used to transmit the terminal uplink signal, based on wireless communication scheme specific information included in the received signal represented by the waveform data. The terminal signal demodulation unit 441 demodulates the received signal represented by the waveform data in accordance with the identified wireless communication scheme, and outputs a symbol obtained by the demodulation to the terminal signal decoding unit 442. The terminal signal decoding unit 442 decodes the symbol input from the terminal signal demodulation unit 441 in accordance with the identified wireless communication scheme to obtain terminal transmission data transmitted from the terminal station 3. Note that the terminal signal decoding unit 442 can also use a decoding scheme having a large calculation load, such as SIC. The base station 4a repeats the processing from step S421.

According to the wireless communication system 1a of the present modification example, the mobile relay station 2a can collectively transmit data, which is received from the plurality of terminal stations 3 and is stored, with good quality in a short period of time at a timing when the mobile relay station 2a can communicate with the base station 4a.

### Second Modification Example of First Embodiment

In the present modification example, the mobile relay station receives terminal uplink signals by the plurality of antennas and transmits terminal downlink signals by the plurality of antennas. Hereinafter, differences from the first modification example of the first embodiment will be mainly described.

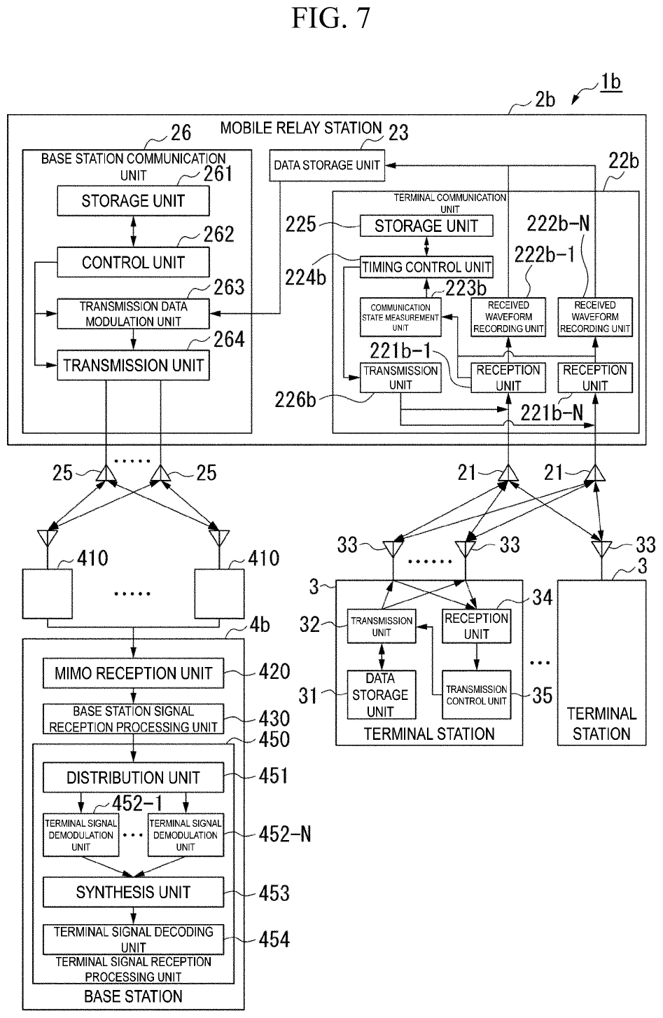

FIG. 7 is a configuration diagram of a wireless communication system 1b according to a second modification example of the first embodiment. In the drawing, the same components as those of the wireless communication system 1a in the first modification example of the first embodiment illustrated in FIG. 5 are denoted by the same reference signs, and description thereof will be omitted. The wireless communication system 1b includes a mobile relay station 2b, a terminal station 3, and a base station 4b.

The mobile relay station 2b includes N antennas 21 (N is an integer of 2 or greater), a terminal communication unit 22b, a data storage unit 23, a base station communication unit 26, and a plurality of antennas 25. The N antennas 21 are referred to as antennas 21-1 to 21-N.

The terminal communication unit 22b includes N reception units 221b and N received waveform recording units 222b. The N reception units 221b are referred to as reception units 221b-1 to 221b-N, and the N received waveform recording unit 222b are referred to as received waveform recording units 222b-1 to 222b-N. The reception unit 221b-n (n is an integer from 1 to N) receives terminal uplink signals by the antenna 21-n. The received waveform recording unit 222b-n samples a received waveform of the terminal uplink signal received by the reception unit 221b-n and generates waveform data indicating a value obtained by the sampling. The received waveform recording unit 222b-n writes received waveform information in the data storage unit 23, the received waveform information being information in which an antenna identifier of the antenna 21-n, a reception time of the terminal uplink signal in the antenna 21-n, and the generated waveform data are set. The antenna identifier is information for identifying g the antenna 21-n. The data storage unit 23 stores the received waveform information including the waveform data of the terminal uplink signal received by each of the antennas 21-1 to 21-N.

The base station 4b includes a plurality of antenna stations 410, a MIMO reception unit 420, a base station signal reception processing unit 430, and a terminal signal reception processing unit 450.

The terminal signal reception processing unit 450 performs processing for receiving a terminal uplink signal indicated by the received waveform information. In this case, the terminal signal reception processing unit 450 performs reception processing by a wireless communication scheme that the terminal station 3 has used for transmission to acquire terminal transmission data. The terminal signal reception processing unit 450 includes a distribution unit 451, N terminal signal demodulation units 452, a synthesis unit 453, and a terminal signal decoding unit 454. The N terminal signal demodulation units 452 are referred to as terminal signal demodulation units 452-1 to 452-N.

The distribution unit 451 reads waveform data at the same reception time from the received waveform information and outputs the read waveform data to the terminal signal demodulation units 452-1 to 452-N in accordance with an antenna identifier associated with the waveform data. That is, the distribution unit 451 outputs the waveform data associated with the antenna identifier of the antenna 21-n to the terminal signal demodulation unit 452-n. Each of the terminal signal demodulation units 452-1 to 452-N demodulates a signal represented by the waveform data and outputs a symbol obtained by the demodulation to the synthesis unit 453. The terminal signal demodulation unit 452-n may perform demodulation after performing processing for compensating for a Doppler shift of the terminal uplink signal received by the antenna 21-n of the mobile relay station 2 on the signal indicated by the waveform data. The Doppler shift of the terminal uplink signal received by each antenna 21-n is calculated in advance based on the position of the terminal station 3 and orbit information of an LEO on which the mobile relay station 2b is mounted. The synthesis unit 453 adds and synthesizes the symbols input from the respective terminal signal demodulation units 452-1 to 452-N and outputs the added and synthesized symbol to the terminal signal decoding unit 454. The terminal signal decoding unit 454 decodes the added and synthesized symbol to obtain terminal transmission data transmitted from the terminal station 3.

In addition, as illustrated in FIG. 7, the mobile relay station 2 further includes a communication state measurement unit 223b, a timing control unit 224b, a storage unit 225, and a transmission unit 226b.

The communication state measurement unit 223b measures the communication state of terminal uplink communication from the plurality of terminal stations 3 in the reception units 221b-1 to 221b-N. For example, the communication state measurement unit 223b measures the number of accesses of terminal uplink communication per unit time from the plurality of terminal stations 3, or a received signal intensity in a frequency band of the terminal uplink communication in the reception units 221b-1 to 221b-N. The communication state measurement unit 223b generates congestion degree information based on the measured information.

Note that the congestion degree information may be information itself indicating the number of accesses of terminal uplink communication per unit time from the plurality of terminal stations 3 or the received signal intensity in the frequency band of the terminal uplink communication. Alternatively, the congestion degree information may be information indicating a level determined based on whether information indicating the number of accesses of terminal uplink communication per unit time from the plurality of terminal stations 3 or the received signal intensity in the frequency band of the terminal uplink communication is within a predetermined threshold range. Alternatively, the congestion degree information may be the value itself of the number of times the same terminal uplink signal is to be repeatedly transmitted by the terminal station 3 to the mobile relay station 2b.

The timing control unit 224b controls a timing when a terminal downlink signal having a transmission permission signal set therein is transmitted to the terminal station 3. The timing control unit 224b acquires congestion degree information generated by the communication state measurement unit 223b. The timing control unit 224b generates a transmission permission signal including the acquired congestion degree information.

The transmission unit 226b acquires the transmission permission signal generated by the timing control unit 224b and transmits a terminal downlink signal having the acquired transmission permission signal set therein from the plurality of antennas 21 in a wireless manner. The transmission unit 226b transmits the signal by LPWA. The transmission unit 226b determines a channel to be used to transmit the terminal downlink signal by the mobile relay station by a method determined in advance in the wireless communication scheme to be used. A timing when the transmission unit 226b transmits the terminal downlink signal is controlled by the timing control unit 224b.

The storage unit 225 stores a transmission start timing for each terminal station 3 which is calculated in advance, based on orbit information of the LEO satellite on which the mobile relay station 2b is mounted, and the position of each terminal station 3. The timing control unit 224b controls the transmission unit 226b so as to transmit a terminal downlink signal having a transmission permission signal set therein to each terminal station 3 at a transmission start timing for each terminal station 3 stored in the storage unit 225.

The timing control unit 224b includes, in the transmission permission signal, for example, congestion degree information, which has been generated at the time of receiving a terminal uplink signal from the same terminal station 3 at a point in time of the previous cycle. Alternatively, the timing control unit 224b may include, in the transmission permission signal, for example, congestion degree information, which has been generated at the time of receiving a terminal uplink signal from the same terminal station 3 in the same time slot in the past. Alternatively, for example, the timing control unit 224b may include, in the transmission permission signal, congestion degree information, which has been generated at a point in time immediately before a timing when the transmission permission signal is transmitted to the terminal station 3 (for example, 1 minute before).

In addition, the storage unit 225 stores terminal identification information for identifying the terminal station 3 and positional information indicating the position of each terminal station 3 in advance. The timing control unit 224b specifies terminal identification information of the terminal station 3 to be notified based on the present position of the terminal station and the position of the terminal station 3. The timing control unit 224b includes the specified terminal identification information in the transmission permission signal.

In addition, as illustrated in FIG. 7, the terminal station 3 further includes a reception unit 34 and a transmission control unit 35. The reception unit 34 receives a terminal downlink signal by the antennas 33. The transmission control unit 35 acquires a transmission permission signal from the terminal downlink signal received by the reception unit 34. The transmission control unit 35 acquires terminal identification information included in the acquired transmission permission signal. When the acquired terminal identification information is terminal identification information associated with the pertinent terminal station, the transmission control unit 35 acquires congestion degree information included in the acquired transmission permission signal. Note that in a case where the acquired terminal identification information is not identification information associated with the pertinent terminal station, the terminal station 3 waits without starting to transmit data to the mobile relay station 2.

The transmission control unit 35 determines the number of times the same terminal uplink signal is to be repeatedly transmitted to the mobile relay station 2 based on the acquired congestion degree information. For example, the transmission control unit 35 acquires congestion degree information indicating the number of accesses of terminal uplink communication per unit time from the plurality of terminal stations 3, or a received signal intensity in a frequency band of the terminal uplink communication in the reception unit 221. In this case, information in which a range of values of the number of accesses or the received signal intensity and the number of times of transmission are associated with each other is stored in advance in, for example, a storage medium included in the terminal station 3. The transmission control unit 35 determines the number of times of transmission based on the number of accesses or the received signal intensity indicated by the congestion degree information.

Alternatively, for example, the transmission control unit 35 acquires congestion degree information indicating the level of congestion (the above-described level 1, level 2, or the like) in the reception unit 221. In this case, information in which the level of congestion and the number of times of transmissions are associated with each other is stored in advance in, for example, a storage medium included in the terminal station 3. The transmission control unit 35 determines the number of times of transmission based on the level of congestion indicated by the congestion degree information. Alternatively, for example, the transmission control unit 35 acquires congestion degree information indicating the number of times of transmission determined in the mobile relay station 2. In this case, the transmission control unit 35 determines the number of times of transmission indicated by the congestion degree information.

The transmission unit 32 starts to transmit a terminal uplink signal. The transmission unit 32 reads sensor data from the data storage unit 31 as terminal transmission data, and transmits a terminal uplink signal having the read terminal transmission data set therein from the antenna 33 in a wireless manner. The transmission unit 32 transmits the signal by LPWA. In addition, the transmission unit 32 repeatedly transmits the same terminal uplink signal the number of times of transmission determined by the transmission control unit 35.

The reception units 221b-1 to 221b-N receive the terminal uplink signals by the plurality of antennas 21. The received waveform recording unit 222 samples received waveforms of the terminal uplink signals received by the reception units 221b-1 to 221b-N and generates waveform data indicating a value obtained by the sampling. Because the terminal station 3 transmits one piece of sensor data a plurality of times, a plurality of pieces of waveform data corresponding to the same terminal uplink signal are generated.

The received waveform recording units 222b-1 to 222b-N select, for example, waveform data having the most satisfactory reception state from among the plurality of pieces of waveform data corresponding to the same terminal uplink signal. The received waveform recording units 222b-1 to 222b-N write received waveform information in the data storage unit 23, the received waveform information being information in which a reception time of the terminal uplink signal in the antenna 21 and the selected waveform data are set. The data storage unit 23 stores the received waveform information written by the received waveform recording units 222b-1 to 222b-N. Note that the received waveform recording units 222b-1 to 222b-N may write, for example, received waveform information in the data storage unit 23, the received waveform information being information in which waveform data generated by averaging the plurality of pieces of waveform data corresponding to the same terminal uplink signal is set.

Operations of the wireless communication system 1b will be described.

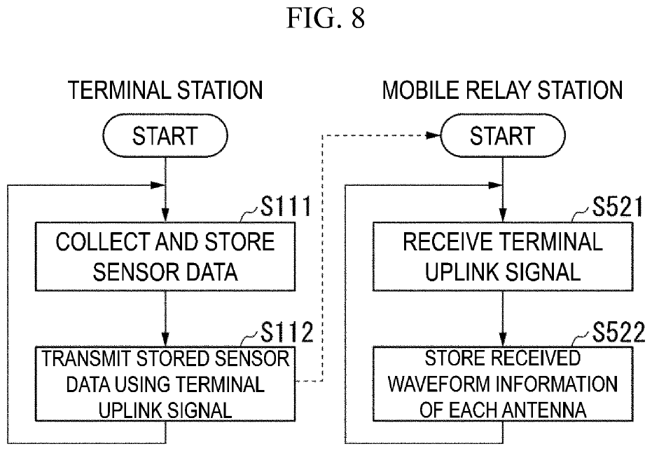

FIG. 8 is a flowchart illustrating processing of the wireless communication system 1b in a case where a terminal uplink signal is transmitted from the terminal station 3. In FIG. 8, the same processing operations as those in the flowchart in the first embodiment illustrated in FIG. 2 are denoted by the same reference signs. The terminal station 3 performs the same processing operations as those of steps S111 to S112 in the flowchart in the first embodiment illustrated in FIG. 2. Note that the terminal station 3, as well as the other terminal stations 3, may perform transmission by time division multiplexing, OFDM, MIMO, or the like.

The reception units 221b-1 to 221b-N of the mobile relay station 2b receive the terminal uplink signal transmitted from the terminal station 3 (step S521). Depending on a wireless communication scheme of the terminal station 3 which is a transmission source, there are a case where terminal uplink signals are received in a time-division manner from the only one terminal station 3 at the same frequency and a case where terminal uplink signals are simultaneously received from a plurality of the terminal stations 3 at the same frequency. The received waveform recording unit 222b-n writes received waveform information in the data storage unit 23, the received waveform information being information in which waveform data representing a waveform of the terminal uplink signal received by the reception unit 221b-n, a reception time, and an antenna identifier of the antenna 21-n are associated with each other (step S522). The mobile relay station 2b repeats the processing from step S521.

The processing of the wireless communication system 1b in a case where a base station downlink signal is transmitted from the mobile relay station 2b is similar to the processing of the flowchart in the first modification example of the first embodiment illustrated in FIG. 6, except for the following processing operations. That is, in step S423, the terminal signal reception processing unit 450 performs processing for receiving a terminal uplink signal indicated by the received waveform information. Specifically, the distribution unit 451 reads waveform data having the same reception time from the received waveform information, and outputs the read waveform data to the terminal signal demodulation units 452-1 to 452-N in accordance with an antenna identifier associated with the waveform data. Each of the terminal signal demodulation units 452-1 to 452-N identifies a wireless communication scheme that the terminal station 3 has used to transmit the terminal uplink signal, based on wireless communication scheme specific information included in the received signal represented by the waveform data. The terminal signal demodulation units 452-1 to 452-N each demodulate the received signal represented by the waveform data in accordance with the identified wireless communication scheme, and outputs a symbol obtained by the demodulation to the synthesis unit 453.

The synthesis unit 453 adds and synthesizes the symbols input from the terminal signal demodulation units 452-1 to 452-N. By the addition and synthesis, signals transmitted by the terminal station 3 are emphasized because the signals are related to each other, but the influence of randomly added noise is reduced. Thus, a diversity effect is obtained for terminal uplink signals that the mobile relay station 2b has received at the same time only from the one terminal station 3. In addition, communication for the terminal uplink signals received by the mobile relay station 2b from the plurality of terminal stations 3 at the same time is equivalent to performing MIMO. The synthesis unit 453 outputs the added and synthesized symbol to the terminal signal decoding unit 454. The terminal signal decoding unit 454 decodes the symbol added and synthesized by the synthesis unit 453 in accordance with the identified wireless communication scheme to obtain terminal transmission data transmitted from the terminal station 3. Note that the terminal signal decoding unit 454 can also use a decoding scheme having a large calculation load such as SIC.

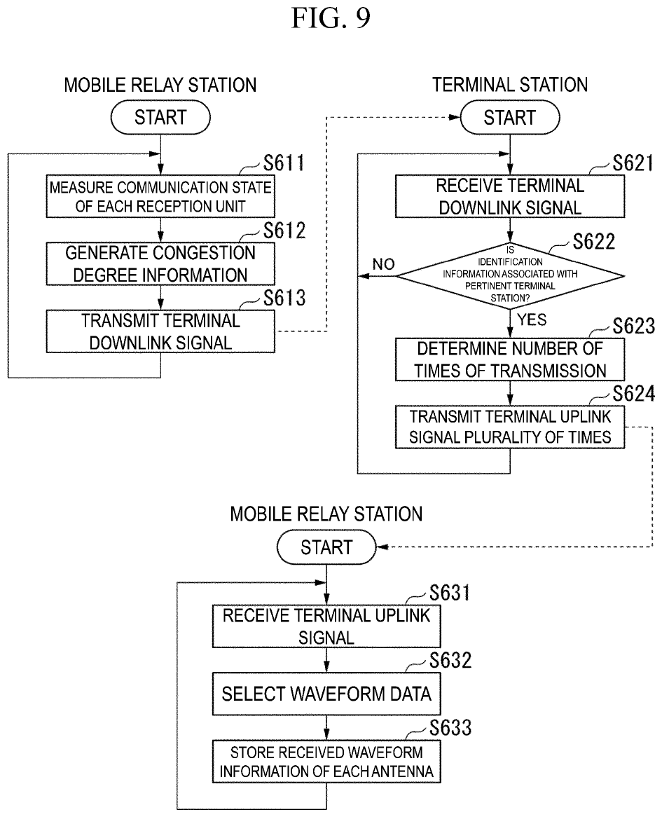

FIG. 9 is a flowchart illustrating processing of the wireless communication system 1b in a case where a terminal downlink signal is transmitted from the mobile relay station 2b. The communication state measurement unit 223b of the mobile relay station 2b measures a communication state of terminal uplink communication from the plurality of terminal stations 3 in the reception units 221b-1 to 221b-N (step S611).

The communication state measurement unit 223b generates congestion degree information used to determine the number of times the same terminal uplink signal is to be repeatedly transmitted by the terminal station 3 to the mobile relay station 2b based on the measured information (step S612). The timing control unit 224b generates transmission permission information including the generated congestion degree information and terminal identification information of the terminal station 3 to be notified. The transmission unit 226b acquires a transmission permission signal generated by the timing control unit 224b. The transmission unit 226b transmits a terminal downlink signal having the acquired transmission permission signal set therein from the plurality of antennas 21 in a wireless manner, for example, at the next cycle (step S613). The mobile relay station 2b repeats the processing from step S611.

The reception unit 34 of each terminal station 3 receives the terminal downlink signal transmitted from the mobile relay station 2b by the antennas 33 (step S621). The transmission control unit 35 acquires terminal identification information included in the transmission permission signal indicated by the terminal downlink signal received by the reception unit 34. In a case where the acquired terminal identification information is terminal identification information associated with the pertinent terminal station (step S622, Yes), the transmission control unit 35 determines the number of times the same terminal uplink signal is to be repeatedly transmitted to the mobile relay station 2b, based on the congestion degree information included in the acquired transmission permission signal (step S623). In a case where the acquired terminal identification information is not terminal identification information associated with the pertinent terminal station (step S622, No), the transmission control unit 35 repeats the processing from step S621.

The transmission unit 32 reads sensor data from the data storage unit 31 as terminal transmission data, and transmits a terminal uplink signal having the read terminal transmission data set therein from the antenna 33 in a wireless manner. The transmission unit 32 transmits the same terminal uplink signal the number of times of transmission determined by the transmission control unit 35 (step S623). The terminal station 3 repeats the processing from step S621.

The reception units 221b-1 to 221b-N of the mobile relay station 2b receive the terminal uplink signals transmitted from the terminal station 3 by the plurality of antennas 21 a plurality of times (step S631). The received waveform recording units 222b-1 to 222b-N sample received waveforms of the plurality of terminal uplink signals received by the reception units 221b-1 to 221b-N and generate waveform data indicating values obtained by the sampling. The received waveform recording units 222b-1 to 222b-N select, for example, waveform data having the most satisfactory reception state from among the plurality of pieces of waveform data corresponding to the same terminal uplink signal (step S632). The received waveform recording units 222b-1 to 222b-N store received waveform information in the data storage unit 23, the received waveform information being information in which a reception time of the terminal uplink signal in the antennas 21 and the selected waveform data are set (step S633). The mobile relay station 2b repeats the processing from step S631.

According to the present modification example, the mobile relay station 2b receives a terminal uplink signal transmitted from each terminal station 3 by diversity reception, MIMO reception, or the like. Thus, according to the wireless communication system 1b of the present modification example, it is possible to improve a link budget of communication between the mobile relay station 2b and the terminal station 3.

### Second Embodiment

In the present embodiment, a wireless communication system includes a plurality of mobile relay stations. In a wireless communication system 1c according to the present embodiment, a transmission timing is controlled such that a terminal uplink signal transmitted from a terminal station 3 is transmitted to a mobile relay station 2c having a relatively low degree of congestion of communication. Hereinafter, differences from the first embodiment will be mainly described.

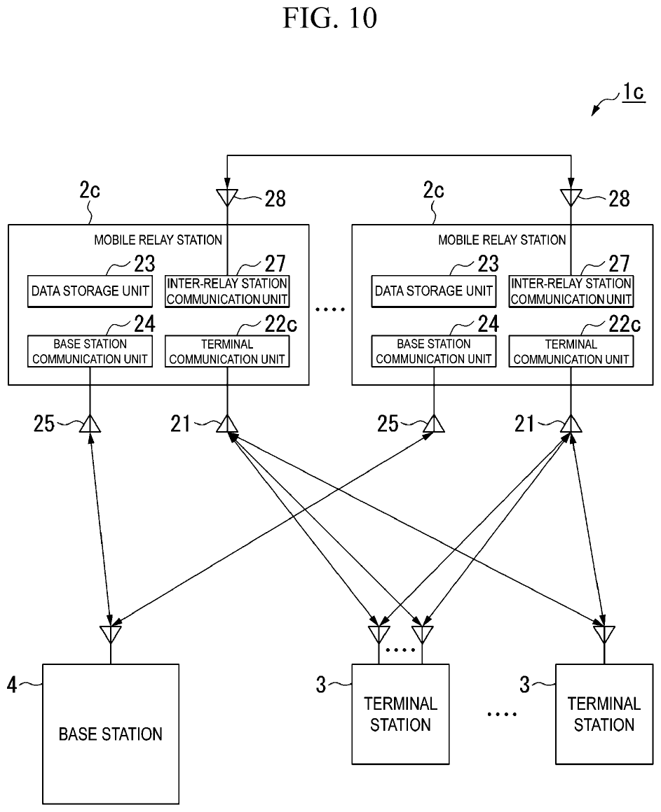

FIG. 10 is a configuration diagram of the wireless communication system 1c according to a second embodiment. In FIG. 10, the same components as those of the wireless communication system 1 according to the first embodiment illustrated in FIG. 1 are denoted by the same reference signs, and description thereof will be omitted. The wireless communication system 1c includes the plurality of mobile relay stations 2c, terminal stations 3, and a base station 4a. The number of the plurality of mobile relay stations 2c, the number of the terminal stations 3, and the number of the base stations 4 included in the wireless communication system 1c are freely determined, and the number of the terminal stations 3 is assumed to be large. The wireless communication system 1c is a communication system transmitting information that does not require immediacy. Information transmitted from the plurality of terminal stations 3 is transmitted via any one of the plurality of mobile relay stations 2c and collected by the base station 4.

Each mobile relay station 2c is an example of a relay device (apparatus) a communicable area of which moves with an elapse of time. The plurality of mobile relay stations 2c are mounted on separate moving bodies. The mobile relay stations 2c are provided in, for example, LEO satellites. The plurality of LEO satellites fly in formation, for example, in low earth orbit. The terminal stations 3 and the base station 4 are installed on the Earth, such as on the ground or at sea. Each terminal station 3 is, for example, an IoT terminal. The terminal station 3 collects data such as environment data detected by a sensor and transmits the collected data to the mobile relay station 2 in a wireless manner. FIG. 10 illustrates only two terminal stations 3. The mobile relay station 2c receives data transmitted from each of the plurality of terminal stations 3 by a wireless signal while moving in the sky of the Earth. The mobile relay station 2c stores the received data and collectively transmits the stored data to the base station 4 in a wireless manner at a timing when the mobile relay station 2c can communicate with the base station 4. The base station 4 receives the data collected by the terminal stations 3 from the mobile relay station 2.

The mobile relay station 2c includes an antenna 21, a terminal communication unit 22c, a data storage unit 23, a base station communication unit 24, an antenna 25, an inter-relay station communication unit 27, and an antenna 28.

The terminal communication unit 22c of each of the mobile relay stations 2c measures the communication state of terminal uplink communication from the plurality of terminal stations 3. For example, the terminal communication unit 22c measures the number of accesses of terminal uplink communication per unit time from the plurality of terminal stations 3, or a received signal intensity in a frequency band of the terminal uplink communication.

The terminal communication unit 22c generates congestion degree information based on the measured information. As described above, the congestion degree information is information used to determine the number of times the same terminal uplink signal is to be repeatedly transmitted by the terminal station 3 to the mobile relay station 2c. Note that the congestion degree information may be information itself indicating the number of accesses of terminal uplink communication per unit time from the plurality of terminal stations 3 or the received signal intensity in the frequency band of the terminal uplink communication.

Alternatively, the congestion degree information may be information indicating a level determined based on whether information indicating the number of accesses of terminal uplink communication per unit time from the plurality of terminal stations 3 or the received signal intensity in the frequency band of the terminal uplink communication is within a predetermined threshold range. Alternatively, the congestion degree information may be the value itself of the number of times the terminal station 3 repeatedly transmits the same terminal uplink signal to the mobile relay station 2c.

The inter-relay station communication units 27 of the respective mobile relay stations 2c can transmit and receive data to and from each other by the antenna 28 (inter-satellite communication). The inter-relay station communication unit 27 transmits the generated congestion degree information to the other mobile relay stations 2c. For example, a communication band of a 23 GHz band is used for communication between the mobile relay stations 2c.

The inter-relay station communication unit 27 transmits the congestion degree information generated by the terminal communication unit 22c to the other mobile relay stations 2c. Thereby, the mobile relay stations 2c can share the congestion degree information. The mobile relay station 2c that transmits a transmission permission signal to the terminal station 3 is determined based on the shared congestion degree information. As described above, the transmission permission signal is a control signal indicating that the terminal station 3 is permitted to transmit data such as environment data to the mobile relay station 2c.

In the present embodiment, the mobile relay station 2c serving as a host is determined in advance, and the mobile relay station 2c serving as the host determines the mobile relay station 2c that transmits a transmission permission signal to the terminal station 3. Congestion degree information generated by each of the mobile relay stations 2c is collected by the mobile relay station 2c serving as the host. The mobile relay station 2c serving as the host determines the mobile relay station 2c that transmits a transmission permission signal to the terminal station 3 based on the collected congestion degree information. For example, the mobile relay station 2c serving as the host determines, for example, the mobile relay station 2c that generates congestion degree information indicating the lowest degree of congestion as the mobile relay station 2c that transmits the transmission permission signal to the terminal station 3. The mobile relay station 2c serving as the host transmits, to the determined mobile relay station 2c, instruction information for transmitting a transmission permission signal to the target terminal station 3.

Note that, in the present embodiment, the mobile relay station 2c serving as the host is configured to determine the mobile relay station 2c that transmits the transmission permission signal to the terminal station 3, but the present disclosure is not limited thereto. For example, the congestion degree information generated in each of the mobile relay stations 2c may be shared by all of the mobile relay stations 2c. In this case, each of the mobile relay stations 2c specifies the mobile relay station 2c that transmits the transmission permission signal to the terminal station 3 based on the collected congestion degree information. Thereby, all of the mobile relay stations 2c can recognize the mobile relay station 2c that transmits the transmission permission signal to the terminal station 3.

The terminal communication unit 22c of the mobile relay station 2c that has received the instruction information for transmitting the transmission permission signal generates the transmission permission signal including the acquired congestion degree information. The terminal communication unit 22c transmits a terminal downlink signal having the generated transmission permission signal set therein from the antennas 21 in a wireless manner. The terminal communication unit 22c transmits the signal by, for example, LPWA. The terminal communication unit 22c determines a channel to be used to transmit the terminal downlink signal by the terminal station by a method determined in advance in the wireless communication scheme to be used.

The terminal communication unit 22c stores a transmission start timing for each terminal station 3 which is calculated in advance, based on orbit information of the LEO satellite on which the mobile relay station 2c is mounted, and the position of each terminal station 3. The orbit information of the LEO is information with which the position, speed, moving direction, and the like of the LEO satellite at any time can be obtained. The transmission time may be represented by, for example, an elapsed time from the transmission start timing. The terminal communication unit 22c transmits the terminal downlink signal having the transmission permission signal set therein to the terminal station 3 at the transmission start timing of the terminal station 3 which is a communication target.

The terminal communication unit 22c includes, in the transmission permission signal, for example, congestion degree information, which has been generated at the time of receiving a terminal uplink signal from the same terminal station 3 at a point in time of the previous cycle. Alternatively, the terminal communication unit 22c may include, in the transmission permission signal, for example, congestion degree information, which has been generated at the time of receiving a terminal uplink signal from the same terminal station 3 in the same time slot in the past. Alternatively, the terminal communication unit 22c may include, in the transmission permission signal, congestion degree information, which has been generated at a point in time immediately before a timing when the transmission permission signal is transmitted to the terminal station 3 (for example, 1 minute before).

In addition, the terminal communication unit 22c stores terminal identification information for identifying the terminal station 3 and positional information indicating the position of the terminal station 3 in advance. The timing control unit 224 specifies terminal identification information of the terminal station 3 to be notified based on the present position of the mobile relay station and the position of the terminal station 3. The timing control unit 224 includes the specified terminal identification information in the transmission permission signal.

Note that, in the present embodiment, the mobile relay station 2c serving as the host specifies the mobile relay station 2c having the lowest degree of congestion, and the specified mobile relay station 2c transmits the transmission permission signal to the terminal station 3 which is a communication target, but the present disclosure is not limited thereto. For example, the mobile relay station 2c serving as the host may specify a time slot in which the degree of congestion is lowest based on the collected congestion degree information and may transmit instruction information for transmitting a transmission permission signal to the mobile relay station 2c passing above the terminal station 3 which is a communication target in the specified time slot.

Operations of the wireless communication system 1c will be described.

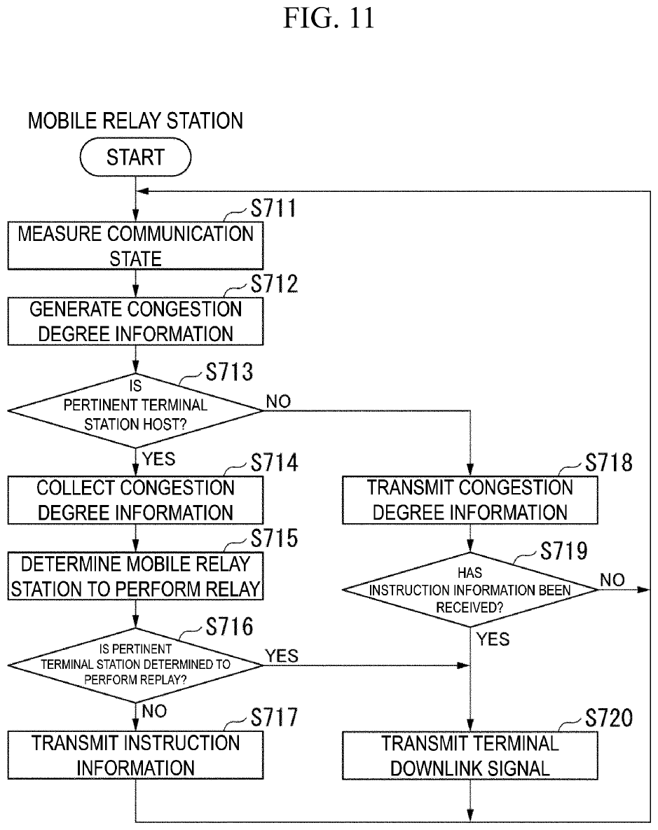

FIG. 11 is a flowchart illustrating processing of each of the mobile relay stations 2c in a case where the mobile relay station 2c transmitting a transmission permission signal is determined. The terminal communication unit 22c measures the communication state of terminal uplink communication from the plurality of terminal stations 3. For example, the terminal communication unit 22c measures the number of accesses of terminal uplink communication per unit time from the plurality of terminal stations 3, or a received signal intensity in a frequency band of the terminal uplink communication (step S711). The terminal communication unit 22c generates congestion degree information based on the measured information (step S712).

In a case where the pertinent mobile relay station is a mobile relay station 2c serving as a host (step S713, Yes), the inter-relay station communication unit 27 of the mobile relay station 2c serving as the host collects congestion degree information transmitted from the other mobile relay stations 2c (step S714). The mobile relay station 2c serving as the host determines the mobile relay station 2c that relays data transmitted from the terminal station 3 to the base station 4 (that is, the mobile relay station 2c that transmits a transmission permission signal to the terminal station 3) based on the collected congestion degree information (step S715).

In a case where the pertinent mobile relay station is not the determined mobile relay station 2c (step S716, No), the inter-relay station communication unit 27 of the mobile relay station 2c serving as the host transmits instruction information for transmitting the transmission permission signal to the determined mobile relay station 2c (step S717). In a case where the pertinent mobile relay station is the determined mobile relay station 2c (step S716, Yes), the terminal communication unit 22c of the mobile relay station 2c serving as the host transmits a terminal downlink signal in which the transmission permission signal including the congestion degree information is set (step S720). The mobile relay station 2c serving as the host repeats the processing from step S711.

In a case where the pertinent mobile relay station is not the mobile relay station 2c serving as the host (step S713, No), the inter-relay station communication unit 27 transmits the generated congestion degree information to the mobile relay station 2c serving as the host (step S718). In a case where the inter-relay station communication unit 27 has received the instruction information for transmitting the transmission permission signal which has been transmitted from the mobile relay station 2c serving as the host (step S719, Yes), the terminal communication unit 22c transmits the terminal downlink signal in which the transmission permission signal including the congestion degree information is set (step S720). The mobile relay station 2c repeats the processing from step S711.

According to the wireless communication system 1c of the second embodiment, the plurality of mobile relay stations 2c receive terminal uplink signals transmitted from the plurality of terminal stations 3 and measure a reception state. The plurality of mobile relay stations 2c generate congestion degree information based on the reception state. The wireless communication system 1c determines the mobile relay station 2c that transmits a transmission permission signal to each of the terminal stations 3 based on the congestion degree information generated by each of the plurality of mobile relay stations 2c. With such a configuration, the wireless communication system 1c can perform data transmission from the terminal station 3 to the base station 4 through the mobile relay station 2c having a lower degree of congestion of communication, and thus efficient communication can be achieved.

In addition, the determined mobile relay station 2c sets the transmission permission signal including the congestion degree information as a terminal downlink signal and transmits the terminal downlink signal to the terminal station 3. The terminal station 3 starts to transmit the terminal uplink signal to the mobile relay station 2c by acquiring the transmission permission signal indicated by the received terminal downlink signal. With such a configuration, the wireless communication system 1 can control a transmission timing of the terminal uplink signal from the terminal station 3 to the mobile relay station 2c.

In addition, the terminal station 3 determines the number of times the terminal uplink signal is to be repeatedly transmitted, based on the congestion degree information included in the transmission permission signal. With such a configuration, the wireless communication system 1 can perform control so that the number of times the terminal uplink signal is to be transmitted from the terminal station 3 is reduced as the degree of congestion of communication in the mobile relay station 2c becomes higher. Thus, the wireless communication system 1c can transmit sensor data transmitted from a greater number of the terminal stations 3 to the base station 4 through the mobile relay stations 2c while suppressing a reduction in the reliability of communication even when the degree of congestion of communication varies.

Note that, in the above-described embodiments, a case where the moving body on which the mobile relay station is mounted is an LEO satellite has been described, but the moving body may be another flying object that flies in the sky such as a geostationary orbit satellite, a drone, and a HAPS.

According to the above-described embodiments and modification examples thereof, a wireless communication system includes a plurality of communication devices present at different locations, a relay device included in a moving body and communicating with the plurality of communication devices in a wireless manner, and a base station device. For example, each communication device corresponds to the terminal station 3 in the embodiments, and the relay device corresponds to the mobile relay stations 2, 2a, 2b, and 2c in the embodiments, and the base station device corresponds to the base stations 4, 4a, and 4b in the embodiments.

The relay device includes a first reception unit, a measurement unit, and a first transmission unit. For example, the first reception unit corresponds to the antenna 21 and the reception units 221 and 221b in the embodiments, and the measurement unit corresponds to the communication state measurement units 223 and 223b in the embodiments, and the first transmission unit corresponds to the antenna 21 and the transmission units 226 and 226b in the embodiments. The first reception unit receives signals transmitted from the plurality of communication devices. For example, the signal corresponds to the terminal uplink signal in the embodiments. The measurement unit measures the degree of congestion of communication in the first reception unit. The first transmission unit transmits congestion degree information based on the degree of congestion to the communication device when the relay device is located in a range in which the relay device can communication with the communication device.

The communication device includes a second reception unit and a second transmission unit. For example, the second reception unit corresponds to the antenna 33 and the reception unit 34 in the embodiments, and the second transmission unit corresponds to the antenna 33 and the transmission unit 32 in the embodiment. The second reception unit receives congestion degree information. The second transmission unit transmits a signal to the relay device the number of times determined based on the congestion degree information. For example, the signal corresponds to the terminal uplink signal in the embodiments.

The base station device communicates with the relay device in a wireless manner. The relay device transmits a signal based on signals transmitted from the plurality of communication devices to the base station device when the relay device is located in a range in which the relay device can communicate with the base station device. For example, the signal based on the signals transmitted from the plurality of communication devices corresponds to the base station downlink signal in the embodiments.

Note that information based on the degree of congestion includes information indicating the number of accesses of signals per unit time in the reception unit, information indicating a received signal intensity of a signal, or information indicating the number of times of transmission.

The relay device may be provided in a moving body that orbits around the Earth, and the first transmission unit may transmit, to the communication device, information based on the degree of congestion measured in the previous orbit.

The moving body may be a low earth orbit satellite, the communication device may be provided in an IoT terminal, and a signal transmitted from the communication device may be a signal indicating sensor data measured by the IoT terminal.

The first transmission unit may transmit congestion degree information based on the degree of congestion to the communication device when the relay device is located in a range in which the relay device can communicate with the communication device in a case where the degree of congestion measured by the measurement unit is relatively low among the degrees of congestion measured in the plurality of relay devices.

Although the embodiments of the present disclosure have been described in detail with reference to the drawings, a specific configuration is not limited to the embodiments, and a design or the like in a range that does not depart from the gist of the present disclosure is included.

### REFERENCE SIGNS LIST

1, 1a, 1b, 1c Wireless communication system
2, 2a, 2b, 2c Mobile relay station
3 Terminal station
4, 4a, 4b Base station
21, 21-1 to 21-N Antenna
22, 22b, 22c Terminal communication unit
23 Data storage unit
24 Base station communication unit
25 Antenna
26 Base station communication unit
27 Inter-relay station communication unit
28 Antenna
31 Data storage unit
32 Transmission unit
33 Antenna
34 Reception unit
35 Transmission control unit
41 Antenna
42 Reception unit
43 Base station signal reception processing unit
44 Terminal signal reception processing unit
221, 221b, 221b-1 to 221b-N Reception unit
222, 222b, 222b-1 to 222b-N Received waveform recording unit
223, 223b Communication state measurement unit
224, 224b Timing control unit
225 Storage unit
226, 226b Transmission unit
241 Storage unit
242 Control unit
243 Transmission data modulation unit
244 Transmission unit
261 Storage unit
262 Control unit
263 Transmission data modulation unit
264 MIMO transmission unit
410 Antenna station
420 MIMO reception unit
430 Base station signal reception processing unit
441 Terminal signal demodulation unit
442 Terminal signal decoding unit
450 Terminal signal reception processing unit
451 Distribution unit
452, 452-1 to 452-N Terminal signal demodulation unit
453 Synthesis unit
454 Terminal signal decoding unit

1. A relay device provided in a moving body and configured to communicate with a plurality of communication devices present at different locations in a wireless manner, the relay device comprising:
a processor; and
a storage medium having computer program instructions stored thereon, wherein the computer program instructions, when executed by the processor, perform to;
receive a signal transmitted from each of the plurality of communication devices;
measure a degree of congestion of communication in the receiving; and
transmit information to each communication device when the relay device is located in a range in which the relay device is able to communicate with the communication device, the information being used to determine the number of times of transmission of the signal to be transmitted from the communication device and being based on the degree of congestion.

2. The relay device according to claim 1, wherein
the information based on the degree of congestion is information indicating the number of accesses of the signal per unit time in the receiving, information indicating a received signal intensity of the signal, or information indicating the number of times of transmission.

3. The relay device according to claim 1, wherein
the relay device is provided in the moving body configured to orbit around the Earth, and wherein the computer program instructions further perform to;
transmit the information based on the degree of congestion measured in a previous orbit to the communication device.

4. The relay device according to any one of claim 1, wherein
the moving body is a low earth orbit satellite,
the communication device is provided in an IoT terminal, and
the signal is a signal indicating sensor data measured by the IoT terminal.

5. A wireless communication system comprising:
a plurality of communication devices present at different locations; and
a relay device provided in a moving body and configured to communicate with the plurality of communication devices in a wireless manner, wherein
the relay device comprising:
a processor; and
a storage medium having computer program instructions stored thereon, wherein the computer program Instructions, when executed by the processor, perform to:
receive a signal transmitted from each of the plurality of communication devices,
measure a degree of congestion of communication in the receiving, and
transmit congestion degree information based on the degree of congestion to each communication device when the relay device is located in a range in which the relay device is able to communicate with the communication device, and
each communication device comprising:
a processor; and
a storage medium having computer program instructions stored thereon, wherein the computer program instructions, when executed by the processor, perform to:
receive the congestion degree information, and
transmit the signal to the relay device the number of times of transmission determined based on the congestion degree information.

6. The wireless communication system according to claim 5, further comprising:
a base station device configured to communicate with the relay device in a wireless manner, wherein
the relay device transmits, to the base station device, a signal based on the signal transmitted from each of the plurality of communication devices when the relay device is located in a range in which the relay device is able to communicate with the base station device.

7. A wireless communication system comprising:
a plurality of communication devices present at different locations; and
a plurality of relay devices configured to communicate with the plurality of communication devices in a wireless manner, each relay device being provided in a corresponding one of a plurality of moving bodies, wherein
each relay device comprising:
a processor; and
a storage medium having computer program instructions stored thereon, wherein the computer program instructions, when executed by the processor, perform to:
receive a signal transmitted from each of the plurality of communication devices,
measure a degree of congestion of communication in the receiving, and
transmit congestion degree information based on the degree of congestion to each communication device when the relay device is located in a range in which the relay device is able to communicate with the communication device in a case where the measured degree of congestion is relatively low among the degrees of congestion measured in the plurality of relay devices, and
each communication device comprising:
a processor; and
a storage medium having computer program instructions stored thereon, wherein the computer program instructions, when executed by the processor, perform to:
receive the congestion degree information, and
transmit, to the relay device that has transmitted the congestion degree information, the signal the number of times of transmission determined based on the congestion degree information.

8. A wireless communication method executed by a relay device provided in a moving body and configured to communicate with a plurality of communication devices present at different locations in a wireless manner, the wireless communication method comprising:
receiving a signal transmitted from each of the plurality of communication devices;
measuring a degree of congestion of communication in the receiving; and
transmitting information to each communication device when the relay device is located in a range in which the relay device is able to communicate with the communication device, the information being used to determine the number of times of transmission of the signal to be transmitted from the communication device and being based on the degree of congestion.

9. A wireless communication method executed by a wireless communication system including a plurality of communication devices present at different locations, and a relay device provided in a moving body and configured to communicate with the plurality of communication devices in a wireless manner, the wireless communication method comprising:
by the relay device, receiving a signal transmitted from each of the plurality of communication devices;
by the relay device, measuring a degree of congestion of communication in the receiving;
by the relay device, transmitting congestion degree information based on the degree of congestion to each communication device when the relay device is located in a range in which the relay device is able to communicate with the communication device;
by each communication device, receiving the congestion degree information; and
by each communication device, transmitting the signal to the relay device the number of times of transmission determined based on the congestion degree information.

10. A wireless communication method executed by a wireless communication system including a plurality of communication devices present at different locations, and a plurality of relay devices configured to communicate with the plurality of communication devices in a wireless manner, each relay device being provided in a corresponding one of a plurality of moving bodies, the wireless communication method comprising:
by each relay device, receiving a signal transmitted from each of the plurality of communication devices;
by each relay device, measuring a degree of congestion of communication in the receiving;
by each relay device, transmitting congestion degree information based on the degree of congestion to each communication device when the relay device is located in a range in which the relay device is able to communicate with the communication device in a case where the measured degree of congestion is relatively low among the degrees of congestion measured in the plurality of relay devices;
by each communication device, receiving the congestion degree information; and
by each communication device, transmitting, to the relay device that has transmitted the congestion degree information, the signal the number of times of transmission determined based on the congestion degree information.
